(19) United States
(12) Patent Application Publication
(10) Pub. No.: US 2012/0066030 A1
(43) Pub. Date: Mar. 15, 2012

(54) Performance Management System And Dashboard

(76) Inventor: Bruce R. Limpert, Elizabethtown, PA (US)

(21) Appl. No.: 12/878,651

(22) Filed: Sep. 9, 2010

(51) Int. Cl. G06Q 10/00

(52) U.S. Cl. 705/7.38

(57) ABSTRACT

A performance management system for straightforward company analytics including trend, peer and industry benchmarking analysis, for performance assessment, measurement and action planning by linking fundamental financial metrics to their business drivers through key performance indicators (KPI's).

The performance management system includes a database module, an action library module, and application module, an assessment module, an analysis module, and a reporting module. The database module collects and stores data, while the action library module maintains performance analysis toolkit domains and sub-domains having action items stored in the database module. The application module allows a user to perform multiple related specific tasks through a single general user interface (GUI). The assessment module provides a customized assessment of business performance through a select domain action item. The analysis module provides analytics of an action plan customized from a selected domain action item linked to a metric of an action plan. The reporting module communicating a simple integrated financial snapshot of business performance over a period of time.

### FIELD OF THE INVENTION

The invention is related generally to a performance management system and method, and in particular, to such a system and method for tracking and assessing performance of company goals and objectives, financial and non-financial metrics, strengths and weaknesses relative to the personal objectives and industry benchmarks.

### BACKGROUND

Business performance management is a set of management and analytic processes enabling optimal management of a business. Generally, business performance management include three main activities, including (1) the selection of goals, (2) the consolidation of measurement information relevant to business's progress against these goals, and (3) the interventions made by managers in light of this information with a view to improving future performance against these goals. Additionally, satisfactory business performance management includes developing assessments to build goals and plans.

As a managerial approach, business performance management considers processes to be strategic assets of a business that must be understood, managed, and improved to deliver value added products and services to clients. Business performance management can be used to better understand businesses and what drives performance through expanded views, including the relationships of data and processes to each other which, when included in the process model, provide for advanced reporting and analysis that would not otherwise be available.

Certain business performance management tools allow a user to define, measure, and analyze select organizational data and processes to improve in selected areas. A user can first assess performance and then develop a baseline from data and/or processes. Then, the user measures or simulates changes to the data and/or processes. As a result, analysis can be performed to compare against baseline results to determine steps for optimal improvement. The user can then select and implement strategic planning actions to achieve overall improvement in the selected areas.

While these business performance management tools are generally known and available, there has been a need for a single user system that can track assessment and performance of company goals and objectives, while also assessing a business' strengths and weaknesses relative to the industry.

### SUMMARY

In light of these shortcomings, the present invention provides a performance management system for straightforward company analytics including trend, peer and industry benchmarking analysis, for performance assessment, measurement and action planning by linking fundamental financial metrics to their business drivers through key performance indicators (KPI's).

The performance management system includes a database module, an action library module, and application module, an assessment module, an analysis module, and a reporting module. The database module collects and stores data, while the action library module maintains performance analysis toolkit domains and sub-domains having action items stored in the database module. The application module allows a user to perform multiple related specific tasks through a single general user interface (GUI). The assessment module provides for developing customized assessments of business performance through a select domain action item. The analysis module provides analytics of an action plan customized from a selected domain action item linked to a metric of an action plan. The reporting module communicates a simple integrated financial snapshot of business performance over a period of time.

### BRIEF DESCRIPTION OF THE DRAWINGS

The invention will now be described by way of example with reference to the accompanying figures of which:

FIG. 1 is a flow diagram of hardware infrastructure for a performance management system according to the present invention;

FIG. 2 is a block diagram of the performance management system and functional modules according to the present invention;

FIG. 3 is a screenshot of a user interface home screen for the performance management system according to the invention;

FIG. 4a is a screenshot of a left portion of an action domain library for an action library module according to the invention;

FIG. 4b is a screenshot of a right portion of the action domain library according to the invention;

FIG. 5 is a screenshot of a user interface screen for an assessment module according to the invention;

FIG. 6a is a screenshot of a user interface screen for an entity selection component of the assessment module according to the invention;

FIG. 6b is another screenshot of the user interface screen for the entity selection component of FIG. 6a;

FIG. 7a is a screenshot of a user interface screen for the assessment builder component of the assessment module according to the invention;

FIG. 7b is another screenshot of the user interface screen for the assessment builder component of FIG. 7a;

FIG. 8 is a screenshot of a user interface screen for a report generated from the assessment builder component according to the invention;

FIG. 9a is a screenshot of a user interface screen for a financial data analyzer component of the assessment module, showing a financial data set input component according to the invention;

FIG. 9b is a screenshot of a user interface screen for the financial data analyzer component of the assessment module, showing a cash flow component according to the invention;

FIG. 9c is a screenshot of a user interface screen for the financial data analyzer component of the assessment module, showing a FI quick link and KPI input component according to the invention;

FIG. 10 is a screenshot of a user interface screen for a multi-period management balance sheet component of the financial data analyzer component according to the invention;

FIG. 11 is a screenshot of a user interface screen for a metrics component of the financial data analyzer component according to the invention;

FIG. 12 is a screenshot of a user interface screen for a peer/reference comparison component of the financial data analyzer component according to the invention;

FIG. 13a is a screenshot of a user interface screen for a data linkage manager component of the assess component, showing a create new action plan from assessment component according to the invention;

FIG. 13b is a screenshot of a user interface screen for the data linkage manager component of the assess component, showing a select actions from metric drivers and enter metric goals component according to the invention;

FIG. 13c is a screenshot of a user interface screen for the data linkage manager component of the assess component, showing an edit action plan contents component according to the invention;

FIG. 13d is a screenshot of the edit action plan contents component, showing an action edit option according to the invention;

FIG. 14 is a screenshot of a user interface screen for a maintain and monitor action plan component of the assess component, showing a view/print action plan working documents component according to the invention;

FIG. 15 is a screenshot of a user interface screen for the maintain and monitor action plan component of the assess component, showing an update action plan responses component according to the invention;

FIG. 16 is a screenshot of a user interface screen for an analyze component according to the invention;

FIG. 17 is a screenshot of a report prepared from selections within the analysis component according to the invention;

FIG. 18 is a screenshot of a user interface screen for another embodiment of a financial data analyzer component of the assessment module; and

FIG. 19 is a screenshot of a report prepared from selections within the financial data analyzer component showing scenarios under various growth assumptions.

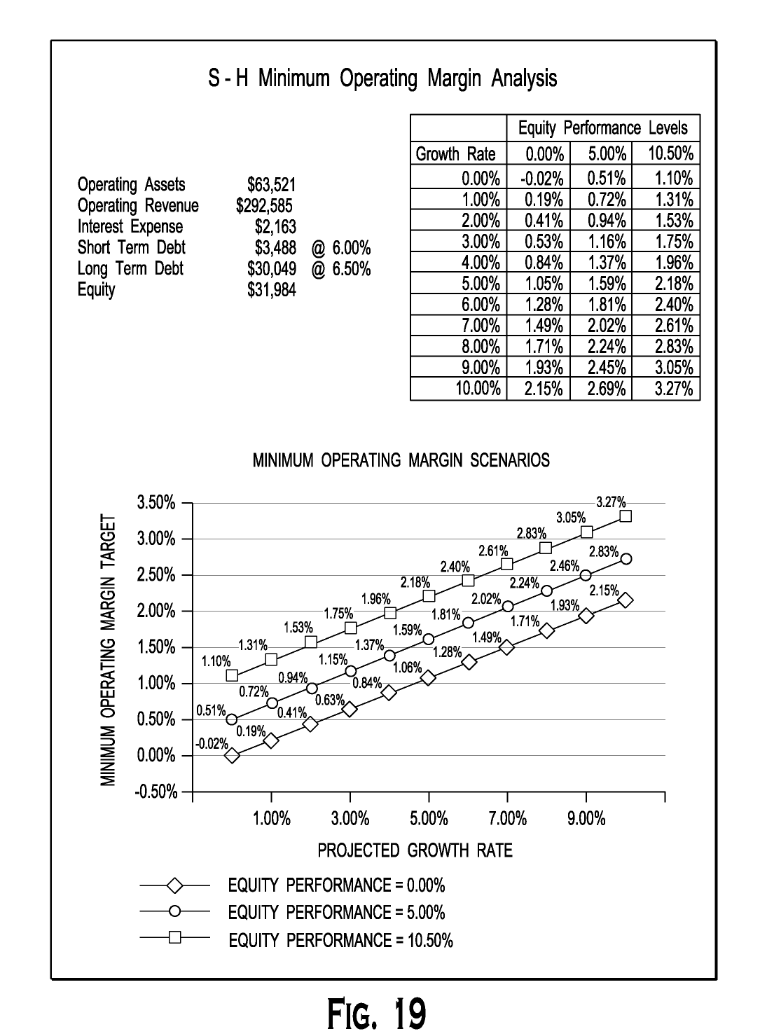

### DETAILED DESCRIPTION OF THE EMBODIMENT(S)

The invention will now be described in greater detail with reference to an embodiment including the attached figures. The embodiments of the invention will be described by an example of a performance management system 1, which employs software and hardware to implement a method for tracking performance of company goals and objectives, assessing company's financial and non-financial metrics, strengths and weaknesses relative to the industry, while setting and monitoring custom assessments and action plans linked to performance driving metrics. These methods are carried out through an application, as a software tool, and provides users with integrated/customized financial summaries and reports that communicate a comprehensive financial snapshot of select action items linked to business metrics and key performance indicators (KPIs). In addition to the financial snapshot of the business, the data can be cast against benchmarks and trends to compare the company to its industry peers.

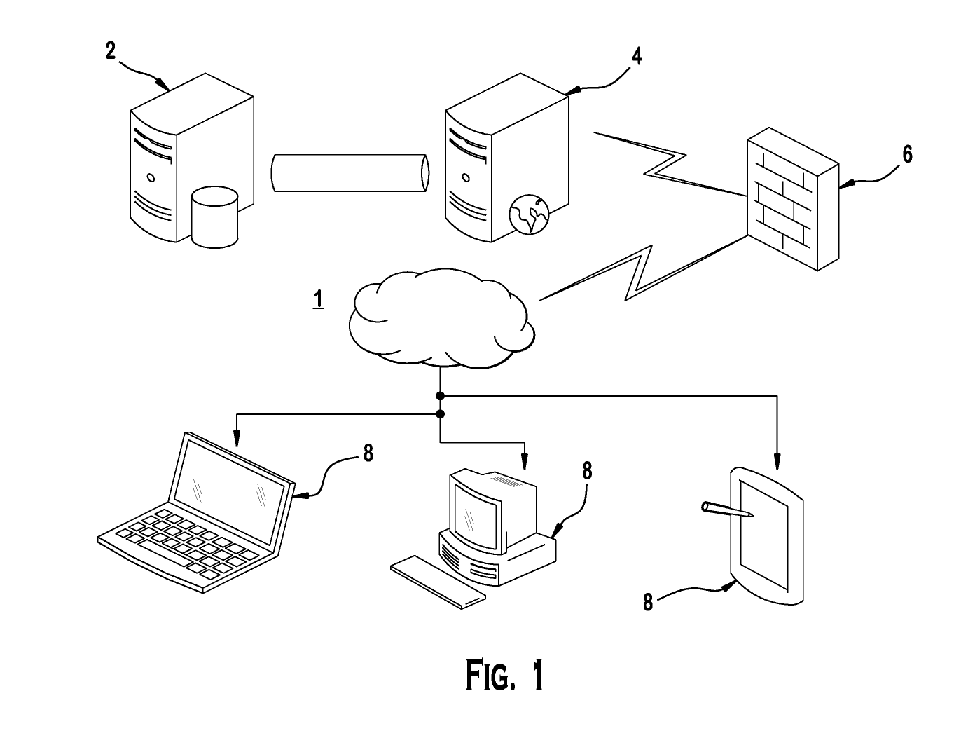

Referring first to the diagram of FIG. 1, the performance management system 1 is built on a .NET/SQL server platform, and utilizes a number of hardware components to utilize the sustainable DuPont Method, the Shattuck-Hammond Minimum Operating Margin (SHMOM), Sustainable Growth, and other business analytics by providing user interface tools to manage a database used to collect, store and report performance in a clear and customized manner. The performance management system 1 stores collected data in a database server 2 (i.e. SQL Server or Windows Server 2008 or newer) that connects to a web server 4. The web server 4 functions in two distinct ways, inter alia: (1) client deployment, and (2) host Windows Communications Foundation Rich Internet Applications (WCF RIA) services to connect an application-programming interface (API) between the end user and the database server. For security, a firewall 6 is integrated with the performance management system 1, which is designed to block unauthorized access to the database and web servers 2, 4, while permitting authorized communication thereto. Although the performance management system 1 can run over personal area networks (PANs), local area networks (LANs), campus area networks (CANs), or metropolitan area networks (MANs), the performance management system 1 is designed to connect to a programmable machine 8 (i.e. desktop computer, laptop computer, smartphone, etc.) to the database and web servers 2, 4 over a wide area network (WAN). As a result, the performance management system 1 is available over a broad area (i.e., any network whose communications links cross metropolitan, regional, or national boundaries).

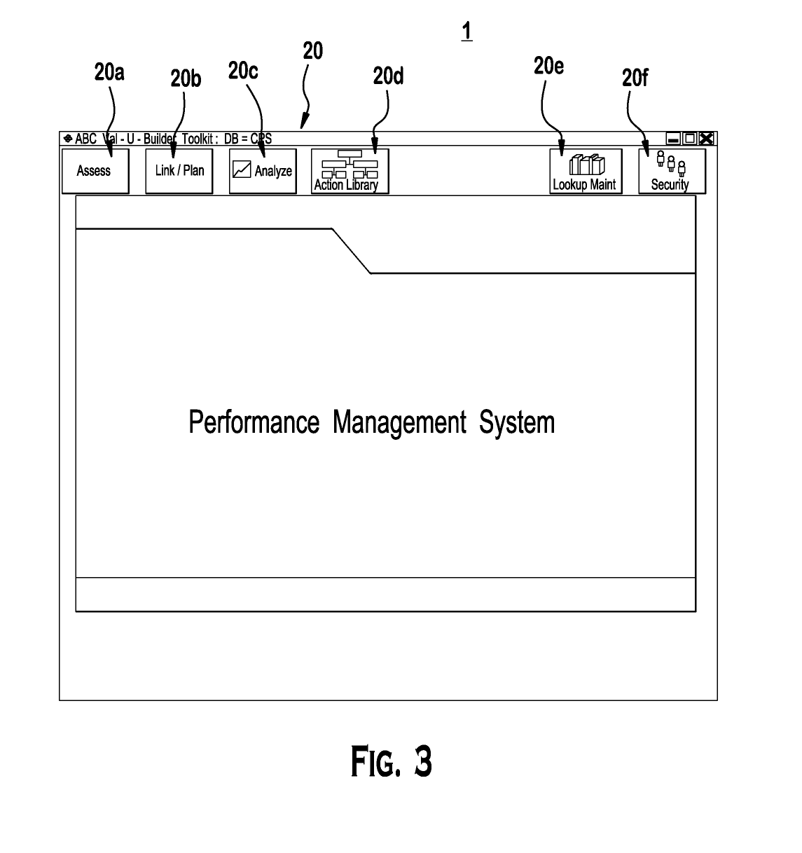

In the embodiments shown in FIGS. 3-18, the performance management system 1 utilizes a .NET user-interface and SQL Server database. The user-interface is built with .NET version 3.5 SP1. The database is version SQL Server 2008. The user-interface is a rich-client application that is deployed using a technology called Click-Once. The installation requires a user to have Internet Explorer version 6.0 or later, Windows Installer 3.1 or later and .NET Framework 3.5 SP1. The performance management system 1 will check for those applications and versions. If they are not installed the performance management system 1 will install them and require a reboot.

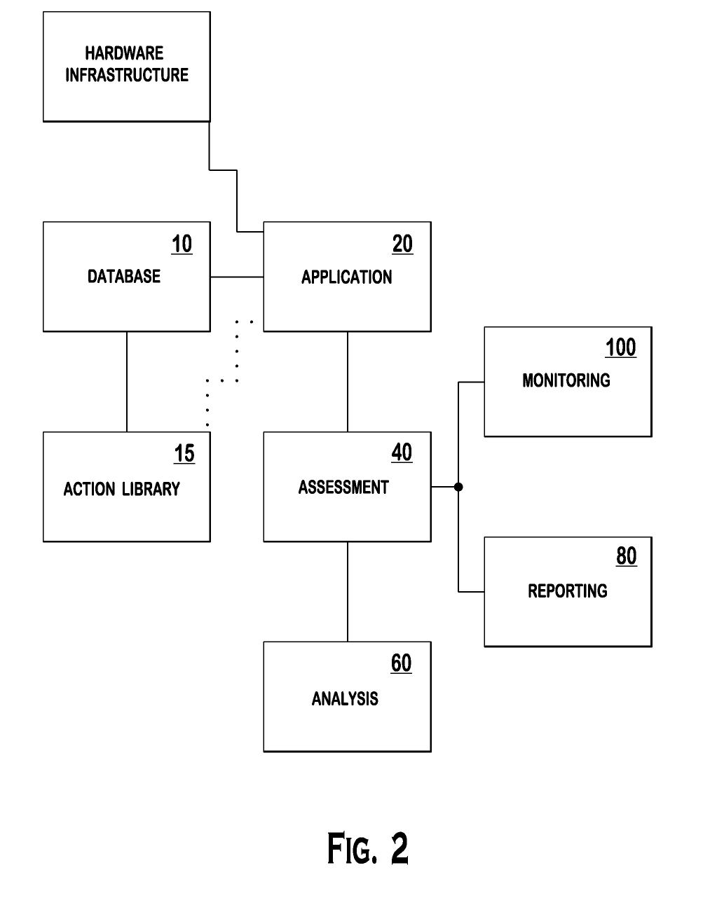

In general, the performance management system 1 runs through a general user interface (GUI), where a user performs tasks through software having a plurality of core modules to map individual action items to generate integrated financial and managerial summaries. The plurality of core modules, as shown in FIG. 2, namely includes a database module 10, an action library module 15, an application module 20, an assessment module 40, an analysis module 60, a reporting module 80, and a monitoring module 100. Each of these modules and their methods of use will now be described in greater detail.

The database module 10 collects, stores, and maintains data for use by the other modules in the performance management system 1. The action library module 15 maintains performance analysis toolkit domains and sub-domains, as well as both assessments and action items associated with these domains. In further, the action library module 15 allows specific actions to be assigned to financial and non-financial information, as key performance indicators (KPIs). The application module 20 is the computer software designed to help a user perform multiple related specific tasks associated with the performance management system 1, through a general user interface (GUI). The assessment module 40 provides the ability to create customized “drill down” assessment of business performance through select financial and non-financial domain actions, capabilities and strategies, which are used to assess the behaviors and to create action plans necessary to track performance outcomes with company objectives. The analysis module 60 provides analytics through selected domain actions including trend, peer and industry benchmarking analysis. The reporting module 80 provides reports and communicates a simple integrated financial picture of a business, as linked to the selected domain actions and customized snapshot of the business over a period of time. The monitoring module 100 provides user ability to monitor customized action plans developed in the performance management system 1.

The specific feature of each core module will be described in furtherance below, with respect to the drawings and through a description of a user's progression through the performance management system 1.

Referring first to the block diagram of FIG. 2, the database module 10 provides a plurality of functionalities, which allow for inbound and outbound data transfer. The database module 10 is an integral part of the performance management system 1, and provides the infrastructure for everything within the performance management system 1 to build upon. The database module 10 stores various financial data in standardized format to allow for peer/industry comparative reports, as well. The database module 10 links all performance management information to a discreet set of financial data. The database module 10 starts with a Lookup maintenance function, which provides the first part of the flexibility within the performance management system 1. The Lookup maintenance function is software code that allows a user to define master files within the database module 10 for available unique/customizable configurations. More importantly, the Lookup maintenance function is used to perform master table maintenance for the entire performance management system 1. The application module 20 is the code controlling the desktop interface, and having a set of command buttons to activate code function and links. The application module 20 runs the performance management system 1 through a graphical user interface (GUI). The application module 20 provides a user access to the database module 10 and utilizes the hardware infrastructure. Through this user interface screen, a user completes commands activating functions the other modules, including the action library module 15, the assessment module 40, the analysis module 60, the reporting module 80, and the monitoring module 100.

Turning now to FIG. 3, the application module 20 is core software that allows the performance management system 1 to run through a series of windows of a general user interface (GUI), and allows a user to manage functionality of the core modules and additional components and features. Various buttons, tabs, and panes are provided throughout the general user interface, which allow the user to select services and activate components of the performance management system 1. Selection of these buttons, tabs, and panes execute software code functioning the core modules, including the database module 10, the action library module 15, the assessment module 40, the analysis module 60, the reporting module 80, and the monitoring module 100.

As shown in FIG. 3, a home screen of the general user interface and applications module 20, is provided, and includes an assess component 20a, a link/plan component 20b, an analyze component 20c, an action library component 20d, a lookup maintenance component 20e and a security component 20f.

The assess component 20a provides workflow functionality to create or select an entity. A user can then configure a selected entity, so that the selected entity can be associated with various assessments, financial data, and action metrics (i.e. financial metrics, nonfinancial metrics such as key performance indicators (KPIs)), all of which is then linked together in what is termed as an action plan. The customized action plan can be maintained and monitored, which may be linked to performed assessments.

The link/plan component 20b is similar to the assess component 20a, such that the link/plan component 20b allows information (financial data and action item metrics) to be linked together for an action plan. However, the link/plan component 20b allows for an ongoing planning engagement with a selected entity, and enabling a user to re-enter previous customization for a selected entity.

The analyze component 20c is used to run financial analyses based on information inputted from the link/plan component 20b and/or the asses component 20a. The financial analyses can be run across multiple financial data sets and metrics.

The lookup maintenance component 20e performs master table maintenance for the performance management system 1, namely the database module 10.

The security component 20f is used to maintain the security roles/groups and users for the performance management system 1.

A particular important feature of the performance management system 1 lies within the action library module 15, as accessed through the action library component 20d in the embodiment shown. More specifically, the action library module 15 is activated by the action library component 20d, which pulls up a separate general user interface window so that the a user can function the action library module 15.

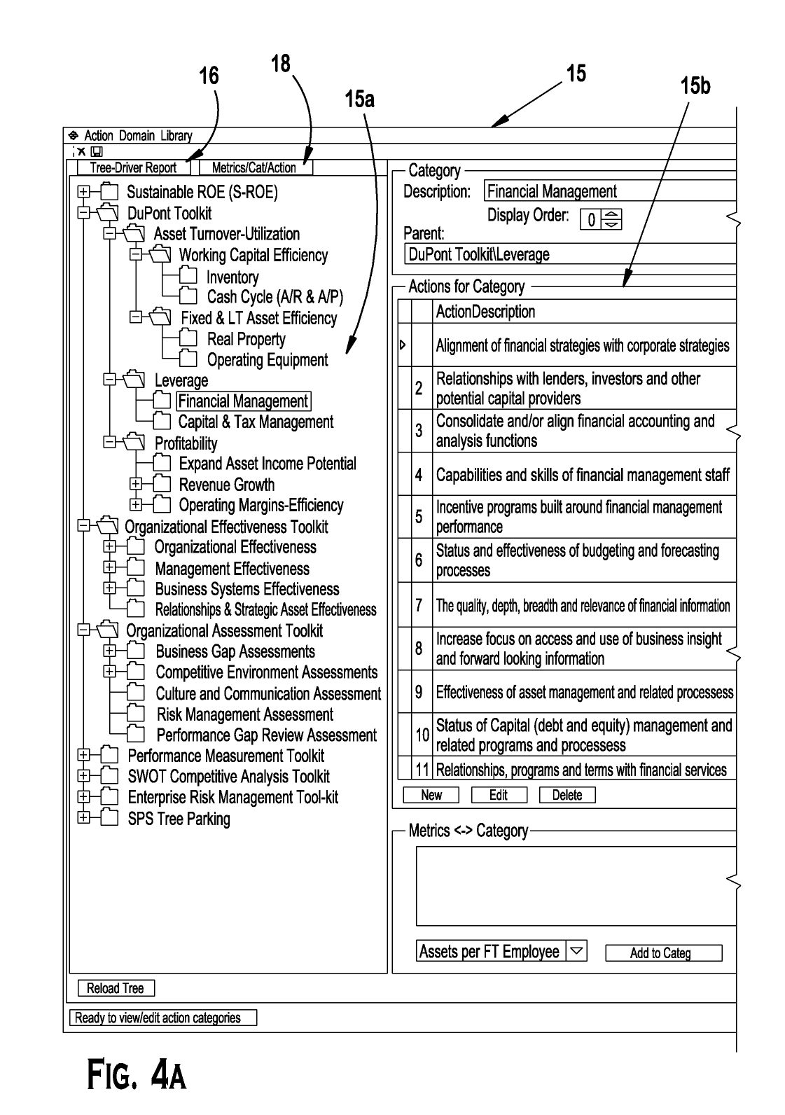

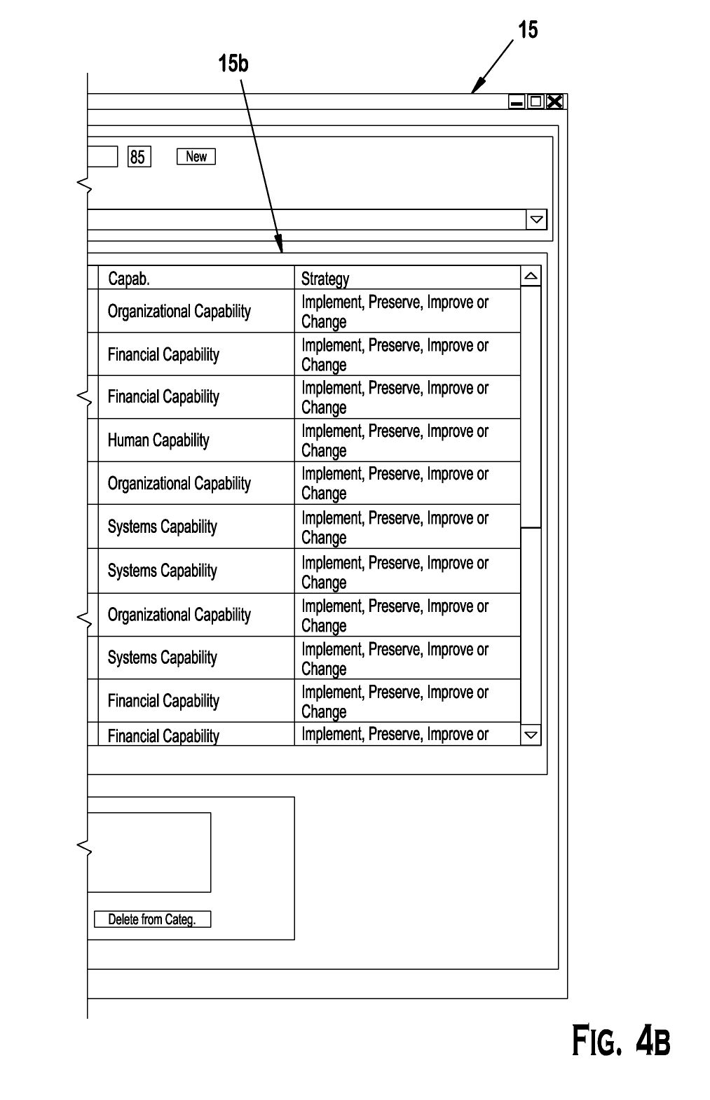

With reference to FIGS. 4a and 4b, the action library module 15 functions through a window having several panes and provides the user ability to define and configure the performance management system 1 toward customized assessment, planning, monitoring, and reporting.

The action library module 15 allows the user to link action items and financial data or KPI Metrics, which are stored within the database module 10. As such, the action library module 15 is a flexible key driver tree having multiple levels, wherein each level having action items can be customized and modified to a business' specific needs. Furthermore, the user can the mapping of KPIs to assessment questions and/or action plans. As a flexible key driver tree, the action library module 15 is completely modifiable, so it can serve as a key bucket hierarchy for other non-financial components and functions. Overall, the action library module 15 provides flexible mapping, linking, storing and retrieval of benchmark or related data collected in the database module 10, so that the user can assess performance across the entire selected entity.

In the embodiment shown, the action library module 15 has a customized action tree 15a of business analyses and toolkits in one windowpane of a general user interface. For instance, the customized action tree 15a includes business analyses/toolkits such as a Sustainable Return on Equity analysis, a DuPont analysis toolkit, an Organizational Effectiveness toolkit, an Organization Assessment toolkit, a Shattuck-Hammond Minimum Operating Margin (SHMOM) analysis, a Performance Measurement toolkit, a Strengths, Weaknesses, Opportunities, and Threats (SWOT) Competitive toolkit, and a Enterprise Risk Management toolkit. In fact, any customized analysis and/or toolkit can be developed by a user and implemented into the customized action tree 15a.

Each of the analysis or toolkits listed in the customized action tree 15a are unique, such that each analysis or toolkit observes and analyzes business performance in different ways, or examines different areas of a particular business. For instance, a key financial measurement for a company's performance is return on equity (ROE). A return on equity analysis may assist to identify key financial trends, capital performance optimization, and reflect the financial result of prior strategic decisions. As a result, the analysis can provide a baseline for internal analysis and strategic planning. A DuPont analysis is a separate measurement of performance, where asset utilization, profitability, and leverage are measured at their book value in order to produce a higher return on equity (ROE). In general, the DuPont analysis identifies if the return on equity (ROE) is affected by three things: (1) profitability, (2) asset efficiency, and (3) leverage. The DuPont Method analysis is also extended and linked to operating performance through the use of the Shattuck-Hammond Minimum Operating Margin (SHMOM). The Sustainable ROE, DuPont, and Shattuck-Hammond Minimum Operating Margin (SHMOM) toolkits are used to analyze different aspects of business performance, while other analyses may factor in even more diverse factors of business performance, all the while being limited and built around customized action plans.

Within the action library module 15, each toolkit contains a list of assessments/action items, which are shown in another windowpane; an action items component 15b in the embodiment shown. The selectable action items are tailored and associated with separate sub-categories of a selected toolkit. Each action item is identified by action description, capability, and strategy, and is listed and grouped by a corresponding toolkit sub-category. For instance, under the Dupont analysis, a manager may want to examine financial leverage through financial management. Action items (i.e. alignment of financial strategies with corporate strategies; effectiveness of asset management and related process) reflecting financial management of the business are listed, and grouped by financial category. The action items are further categorized by capability and strategy. In the embodiment shown, action item capability is categorized as either organization, financial, human, or system capability, while the action item strategy is categorized as either Formula/Terms/Definitions, Assessment Discovery, Business Action Plans, Implement, Preserve, Improve or Change, or Strategic Action Plan.

At the heart of the action library module 15, is the user's ability to link action items to a metric, including financial and non-financial metrics (i.e. key performance indicators (KPIs)). This linking is performed using a metrics-to-category component 15c, positioned in another windowpane of the general user interface, in the embodiment shown. Each action item is linkable to a financial or non-financial metrics. For instance, under the Dupont analysis>>financial leverage>>financial management, a user can link an action item to a financial metric (i.e. specific industry/company customized metric such as Sales/Total Assets, Sales/Equity Financial, Assets per FT Employees, etc.) or a non-financial metric (i.e. Market Weight, Litters/Year/, Sales per Unit Sold) as a Key Performance Indicator-Business Process. Depending on the action item, the metrics-to-category component 15c will allow the user to link any number of metrics with the action item, including a plurality of metrics to a single action item. Accordingly, multiple metrics, including a non-financial and financial metric, can be linked, grouped and reported to a single action item.

With further reference to FIGS. 4a and 4b, in the exemplary embodiment of the action library module 15, two additional components are provided, including the tree-driver report component 16 and the metrics/cat/action component 18, which both assist the user in developing a custom action tree of analyses and or toolkits, which have user defined metrics linked to specific action items.

In the embodiment shown, the tree-driver report component 16 is a button that activating a command to print out a current tailored action tree 15a. Accordingly, the user can select the entire or selected parts of the tailored action tree 15a and receive a report, which lists action items by description, capability, and strategy, as discussed above. The user can use this report to focus assessments and action grouped by a select performance driver of the business (i.e. real property under the DuPont toolkit). The tree-driver report component 16 allows the user to print by domain, which may be all the current toolkits in the action tree 15a, or by filter, including the capability or strategy desired. The metrics/cat/action component 18 allows the user to organize action items through a report listing action items by category.

Fundamentally, the action library module 15 allows the user to customize existing toolkits or prepare new toolkits based on other known or unknown business analyses. The user can then develop strategic and focused performance management through the assessment module 40, the analysis module 60, the reporting module 80, and the monitoring module 100, which utilize the action tree 15a of analyses/toolkits within action library module 15.

Referring back to FIG. 3, once the user has customized the action tree 15a of the action library module 15, the user starts assessment of a selected entity, which is performed through the assess component 20a.

The assess component 20a activates a separate window of the general user interface which is an assessment, financial workup, and action plan component 200 of the performance management system 1. Running through the applications module 20, the assessment, financial workup, and action plan component 200 includes a series of drill down menus and buttons and allows the user to prepare, maintain and monitor a customized action plan for a selected entity.

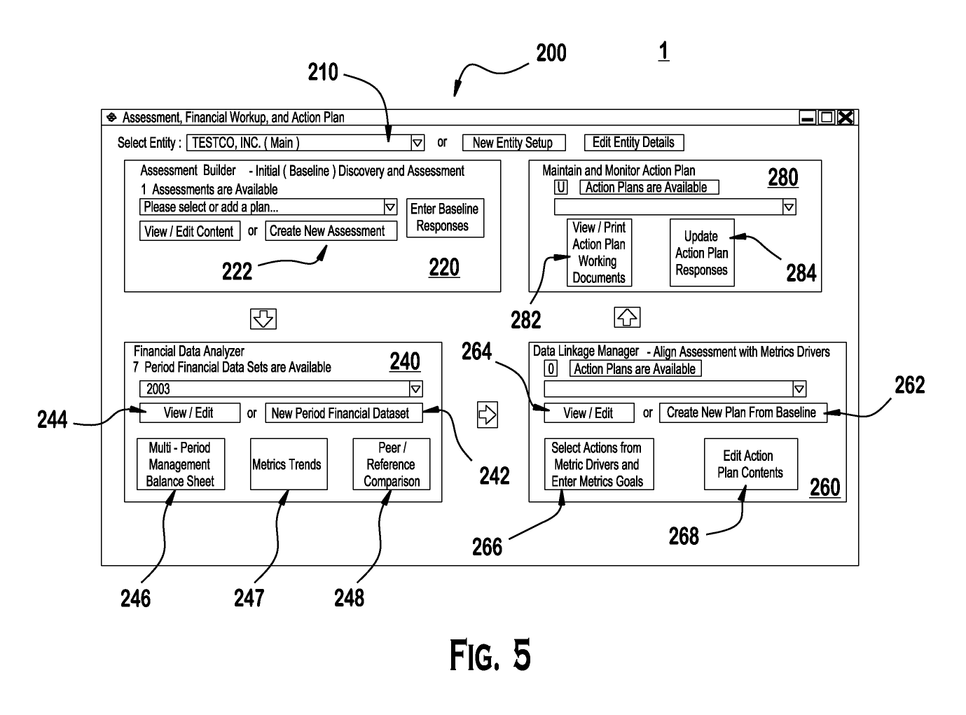

As shown in FIG. 5, the assessment, financial workup, and action plan component 200 provides an entity selection component 210 and an arrangement of sequential components, including an assessment builder component 220, a financial data analyzer component 240, a data linkage manager component 260, and a maintain and monitor action plan component 280. Each of these components 220, 240, 260, and 280 operate to perform certain tasks that utilize the database module 10, the action library module 15, the assessment module 40, the analysis module 60, the reporting module 80, and the monitoring module 100 capabilities of the performance management system 1.

With reference to FIG. 5, the entity selection component 210 allows a user to select and/or edit information regarding an existing entity. In the embodiment shown, the entity may be a company, enterprise or firm. However, it is also possible that the entity be any type of organization, where it would be important to assess and review all aspects of an operation from a combined financial and non-financial perspective.

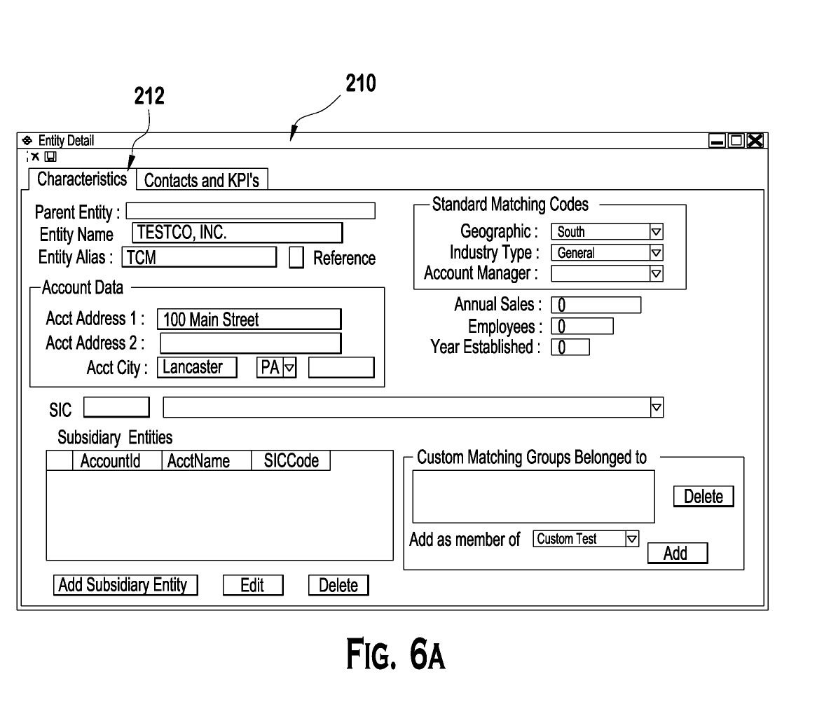

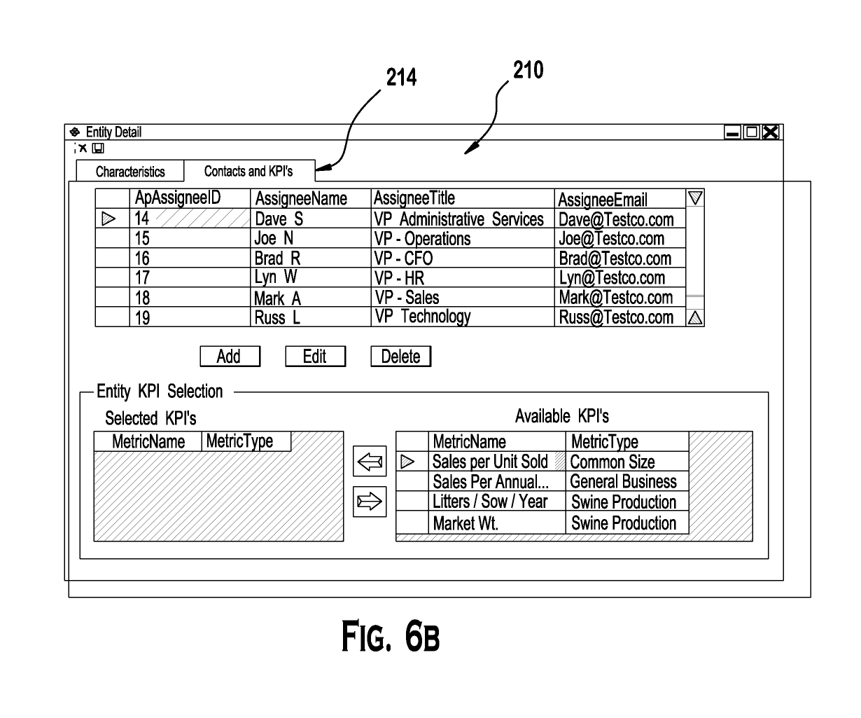

In the embodiment shown, the user selects either an existing entity from a drop down menu or creates an entry for a new entity. The existing entity may have been pre-loaded in the performance management system 1 or previously stored from a prior visit. In the alternative, the user may decide to enter information for new entity or edit an existing entities information. Accordingly, that user is brought to a new window, where the user can add or modify entity detail (i.e. contact information, industry, etc.), as shown in FIGS. 6a and 6b.

In the embodiment shown, the entity selection component 210 includes two functional components to enter or modify entity detail: a characteristic component 212 and a contacts and KPI's component 214.

The characteristic component 212 is a modifiable form that allows input and storing of information concerning a particular entity. In the embodiment shown, this information may include an entity name, address, standard matching codes (i.e. geography, industry type, account manager, etc.), annual sales, number of employees, and year established, inter alia. If applicable, information regarding parent and subsidiary entities may be provided. In addition, a classification system is shown, such as the North American Industry Classification System (NAICS) or Standard Industrial Classification (SIC), which allows the user to define the industry that may be most applicable to the entity. This would allow for more functional benchmarking and industry peer reviews.

The contacts and KPI's component 214 is another modifiable form, which allows the user to input and store information regarding entity contacts and entity key performance indicators (KPIs). The key performance indicators (KPIs) are performance measurements that are not financial metrics. Rather, the key performance indicators (KPIs) are frequently used to value difficult to measure activities, such as the benefits of leadership development, engagement, service, and satisfaction. Generally, key performance indicators (KPIs) are tied to an organization's strategy using concepts or techniques. Key performance indicators (KPIs) differ depending on the nature of the entity and that entity's strategy.

In the performance management system 1, key performance indicators (KPIs) help evaluate progress of a selected entity towards its vision and long-term goals, especially when coupled to action items linked to financial metrics. For instance, in the embodiment shown, a selected entity may keep track of performance through sales per unit sold, market weight, or livestock production, each of which may affect that entities' performance. As a result, keeping track of these metrics allows for analysis that is more refined by linking operating measures to financial performance drivers of an entities' performance. Though the performance management system 1 utilizes financial data as well, the financial data may be entered and/or edited at various stages of performance management.

The performance management system 1 allows the user to input any type of metric, financial or non-financial, which may affect an entities' performance. These metrics can then be linked to selected action items or a group of action items, which focus in on specific areas of an entity and stored in the action library module 15.

Once the user selects a certain entity, the user works through the assessment, financial workup, and action plan component 200, generally starting with the assessment builder component 220. While the performance management system 1 is designed in such a way that the user runs through sequential steps to develop an action plan, the assessment builder component 220, the financial data analyzer component 240, the data linkage manager component 260, and the maintain and monitor action plan component 280 can be accessed and operated in a non-sequential manner. As a result, the user can modify any features within these components 220, 240, 260, and 280.

The assessment builder component 220 is shown in FIG. 5, and provides the user an ability to analyze and assess business performance in particular areas of the selected entity. The assessment builder component 220 includes a number of drill-down menus and buttons that utilize the assessment module 40.

The assessment module 40 provides workflow functionality to configure the selected entity with associated assessment criteria, such as selected action items and metrics (i.e. linked financial metrics and KPIs in action library module 15). More particularly, the assessment module 40 is used to provide a baseline assessment of the selected entity.

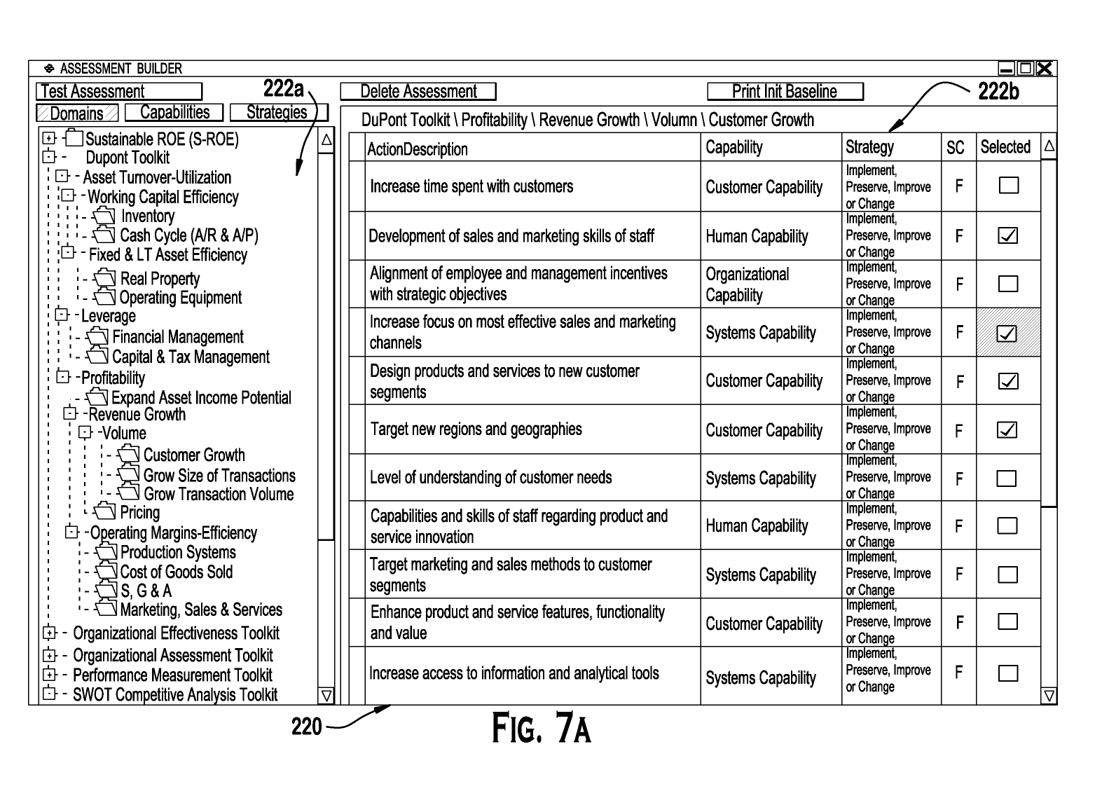

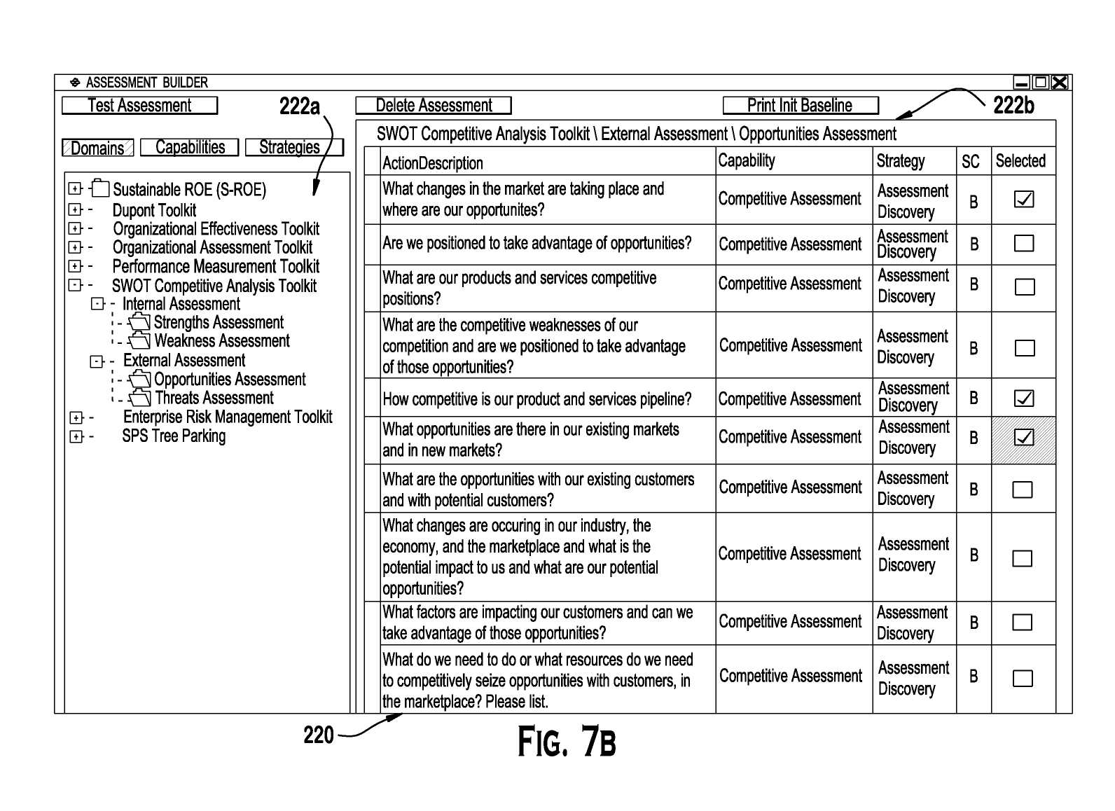

With reference to FIG. 5, the user may create a new assessment or view/edit an existing assessment component 222 by way of the assessment builder component 220. An assessment component 222 (either new or existing) is detailed through the application module 20 as a separate user interface window, as shown in FIGS. 7a and 7b.

In the embodiment shown, the assessment component 222 includes an action tree component 222a and an action item list component 222b, provided in separate panes. The action tree component 222a represents the tailored action tree 15a of the action library module 15, and can be navigated in the same way, as described above. However, instead of linking metrics to specific action items, the assessment component 222 allows the user to select any number of specific action items. For instance, a manager may want to examine profitability through revenue growth as analyzed under the DuPont analysis, while also assessing the competitive strength of opportunities in existing markets by way of the SWOT Competitive analysis toolkit. Accordingly, the assessment component 222 allows the user to do so. The user determines what aspects of the entity to review and analyze, which may affect the performance. Since the analyses/toolkits are linked metrics in the action library module 15, the assessment component 222 provides a baseline assessment according to those select action items.

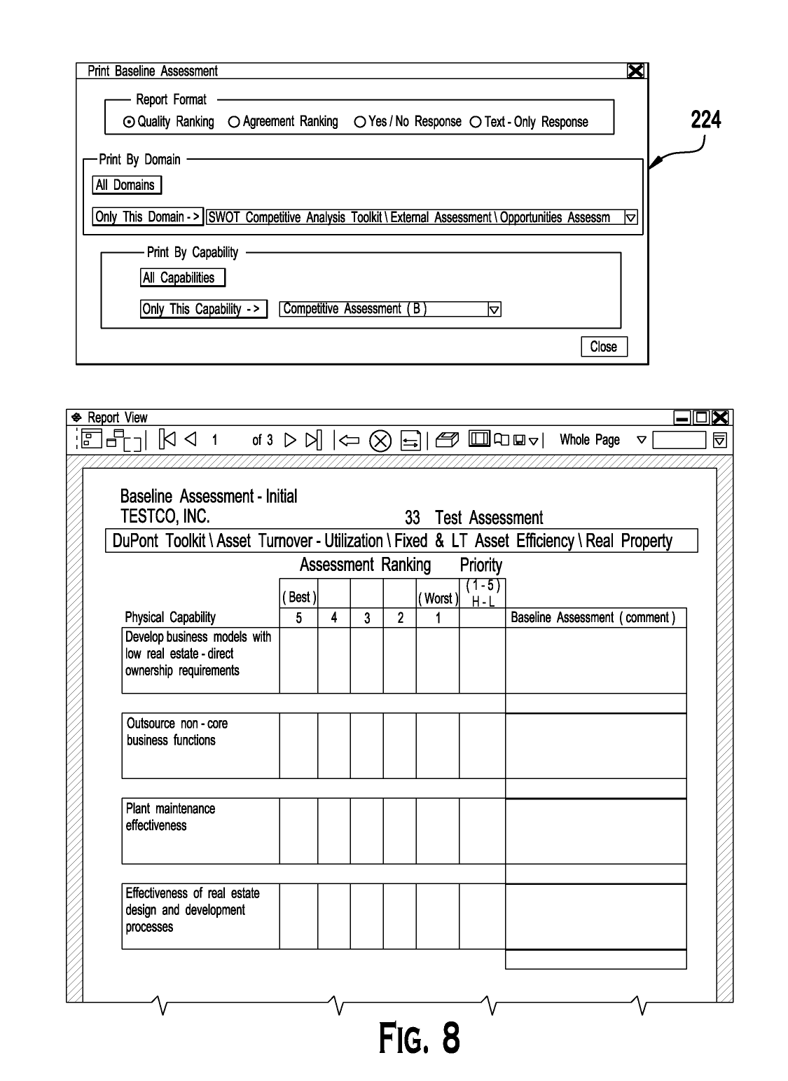

Before financial data is configured and linked to the customized baseline assessment of an entity, a report is prepared by quality ranking, agreement ranking, or other responses, as shown in FIG. 8. A report component 224 generates a report through the assessment component 222 and can be distributed throughout the entity to gather responses and/or rankings associated with selected action items. As a result, the responses and rankings can be entered into the assessment builder component 220, and stored to compare with industry peers, benchmarks or historic entity data, and later in customized action plans. Like the action library module 15, the action items associated with the analyses/toolkits of the action tree component 222a, can be filtered by capability or strategy.

With reference back to FIG. 5, the user can move to the financial data analyzer component 240 to enter financial data, analyze metric trends, and review peer/benchmark comparisons. The financial data analyzer component 240 utilizes the analysis module 60 to link actual or projected financial data by period, as well as values with performance indicators (KPIs) linked to selected entities in the assessment builder component 220.

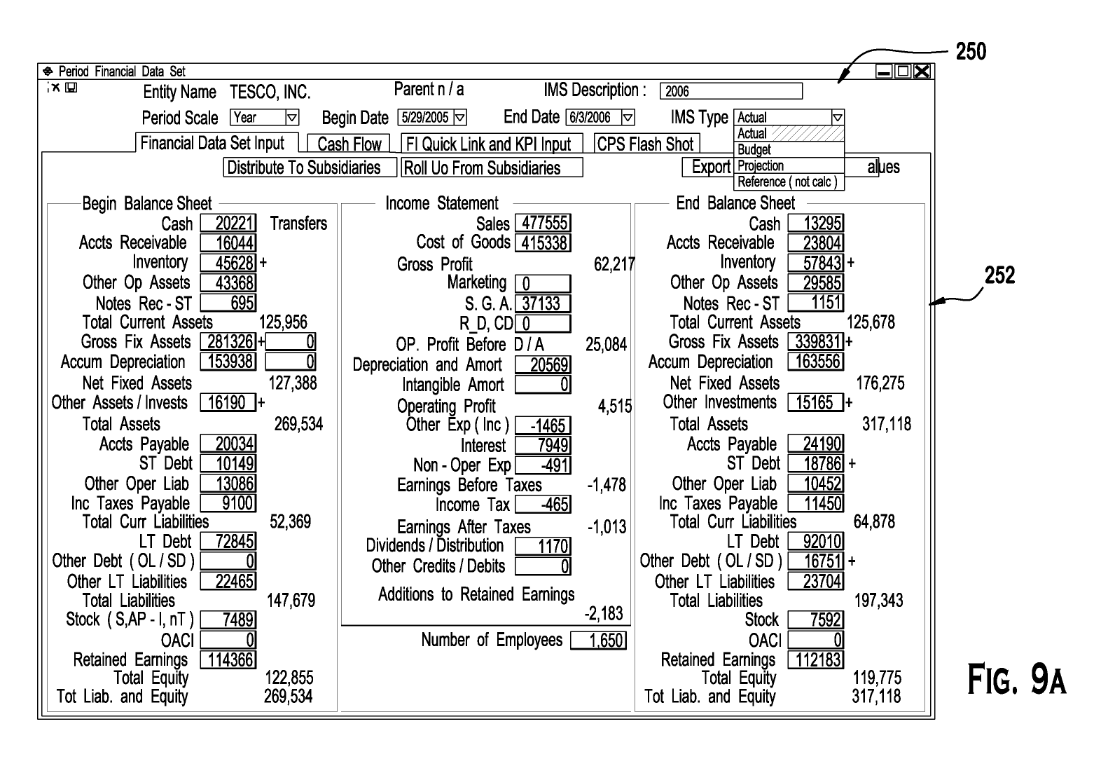

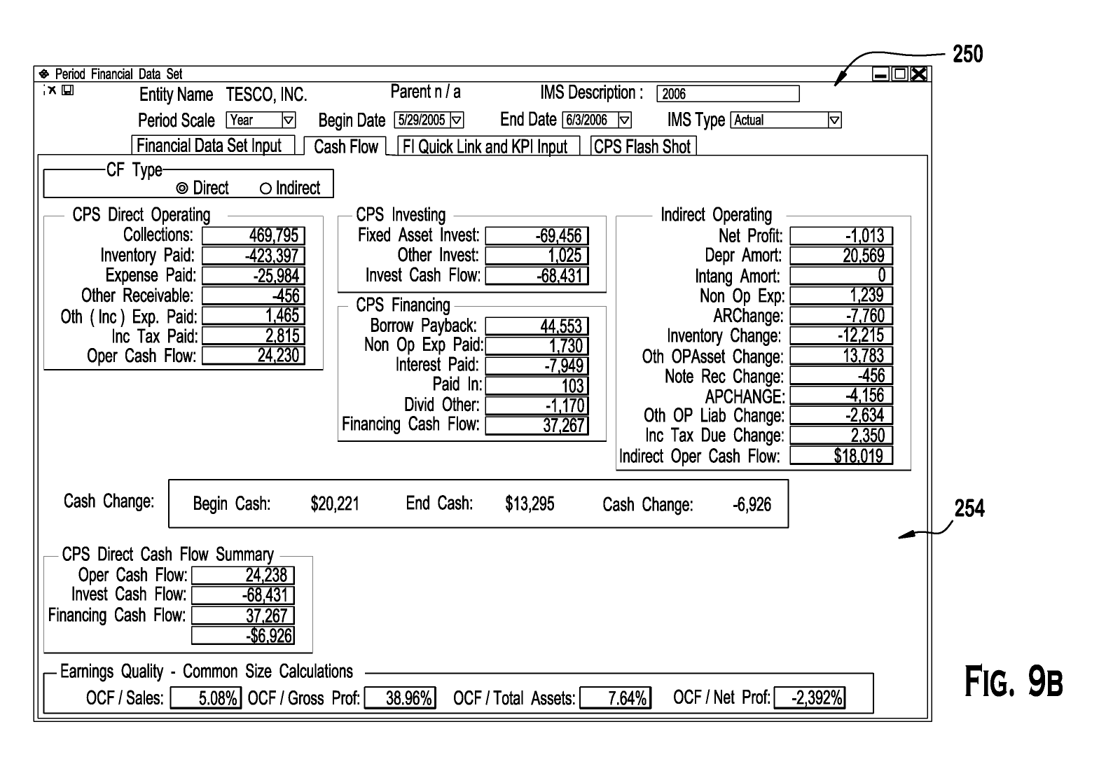

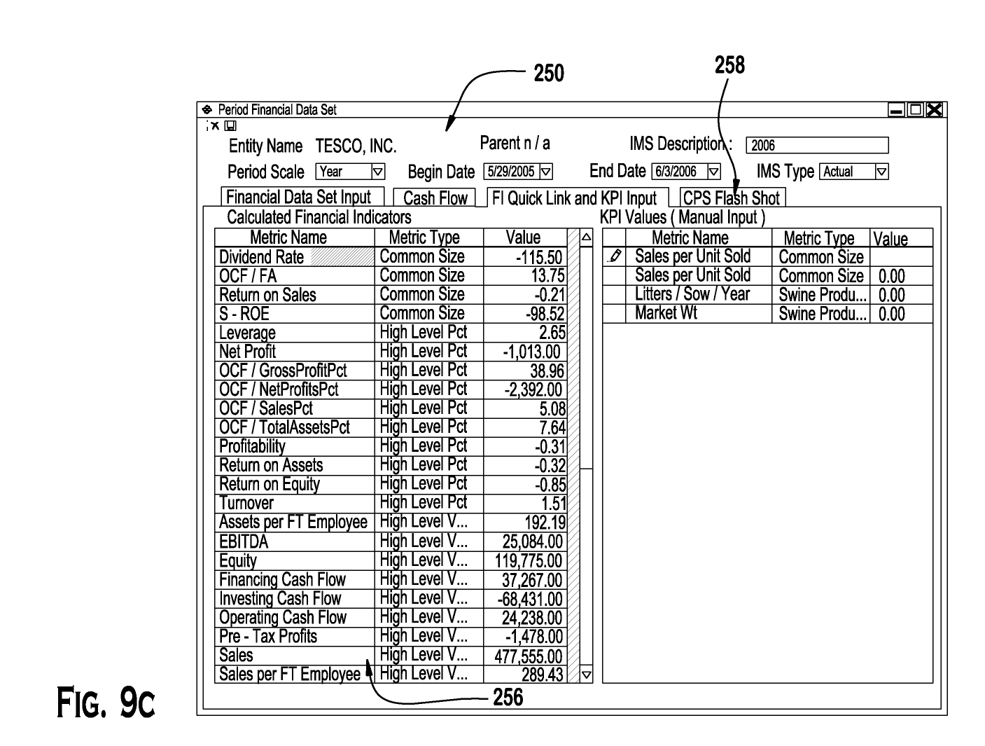

Like the assessment builder component 220, the financial data analyzer component 240 includes a number of drill-down menus and buttons in order to customize the analysis of inputted data. The user can enter new financial data by period by selecting a new period financial dataset component 242 or select a previously entered data set using a drill down menu. If the user selects an existing dataset, there is a view/edit component 244 in order to view or edit a selected data set. By selecting either the new period financial dataset component 242 or the view/edit component 226, a new window provided by the application module 20, as shown in FIGS. 9a and 9b.

With reference to FIGS. 9a-9c, a period financial data set component 250 is shown, and corresponds to the current entity selected with the assessment entity selection component 210. As a result, the user can enter financial data into a form having several components, including a financial data set input component 252, a cash flow component 254, a FI quick link and KPI input component 256, and a CPS flash shot component 258. The financial data can be prepared for a select period of time, including yearly, quarterly, monthly or custom to the user, and can start and end on any historical date. Additionally, the user can enter different types of data, including actual, projected, budgeted, or reference data. The period financial data set component 250 allows the user to label the data in the same way. The reports and assessment plans are linked to a discreet set of financial data.

With respect to the financial data set input component 252, as shown in FIG. 9a, the user can enter financial data in several ways, including manually or automatically, where the data can be imported through a file (i.e. .csv, .xls, etc.). The financial data set input component 252 keeps record of the beginning and ending balance sheets of the prescribed time periods, which include the value of cash, accts receivable, inventory, other operating assets, etc, as well as total assets and liabilities. The user can enter the number of employees and income statement data, such as sales, cost of goods, profits, interest, taxes, and earnings. The total amount of equity and liabilities is calculated.

The cash flow component 254, as shown in FIG. 9b, provides the user the ability to analyze direct and indirect cash flow data generated by the analysis module 60 for the selected entity. Collections, inventory paid, expense paid, other receivables, inter alia, are listed, which provide the user with a operating cash flow total. Other direct cash flow outlets are analyzed including entity investments and finances. Indirect operating cash flow is recorded as well. The cash flow component 254, through the analysis module 60 determines and reports changes in cash flow, from beginning and through the selected end period. A common-size analysis is also analyzed and reported, which expresses each line item on selected time period's financial statement as a percent of a line item. By comparing two or more time periods of common-size statements, changes in the mixture of assets, liabilities, and equity become evident.

The FI quick link and KPI input component 256, as shown in FIG. 9c, provides a listing of financial and non-financial metrics linked to the selected entity, as customized in the action library module 15. The financial metric values are generated by the analyze module 60, while the non-financial metrics, key performance indicators (KPIs) are value entered by the user, or inputted from another source. The CPS flash shot component 258 provides a comprehensive financial summary for a single set of financial data presented in standard formats.

Once data has been entered into the financial data analyzer component 240, and subsequently generated by the analyze module 60, the financial data analyzer component 240 is used to review and analyze custom balance sheets, metric trends, and peer/benchmark comparisons. Accordingly, the financial data analyzer component 240 has several other features including a multi-period management balance sheet component 246, a metric trends component 247, and a peer/reference comparison component 248; each of which are activated by buttons (having the same name) in the embodiment shown in FIG. 5.

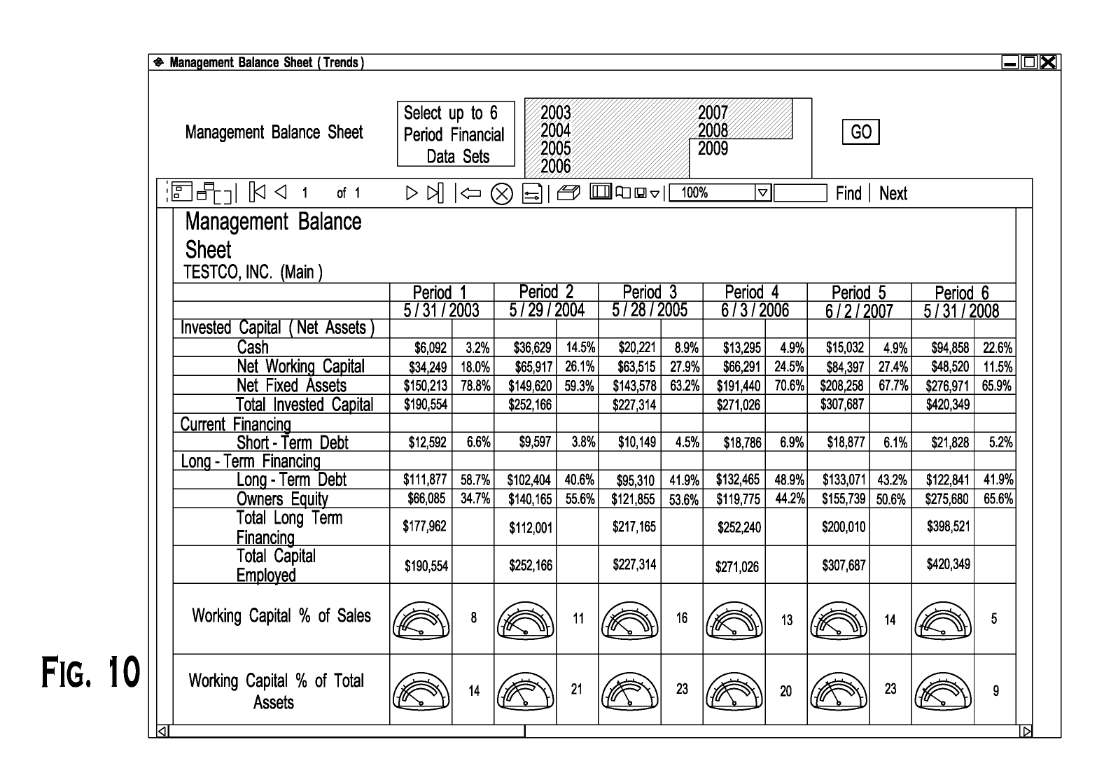

The multi-period management balance sheet component 246 generates a report listing and illustrating a summary of financial balances, as shown in FIG. 10. Assets, liabilities and ownership equity are listed by a specific time period, such as the end of a financial year. The multi-period management balance sheet component 246 generates a snapshot of a selected entities financial condition, which applies to a single point in time as selected by the user of the performance management system 1. Furthermore, the multi-period management balance sheet component 246 provides a value and illustration of working capital percentage (%) of sales and total assets, as calculated by the analysis module 60. This provides the ability to trend how capital is invested and focused, and compares how growth is being financed It also allows for comparative analysis against various components of the entities capital cost.

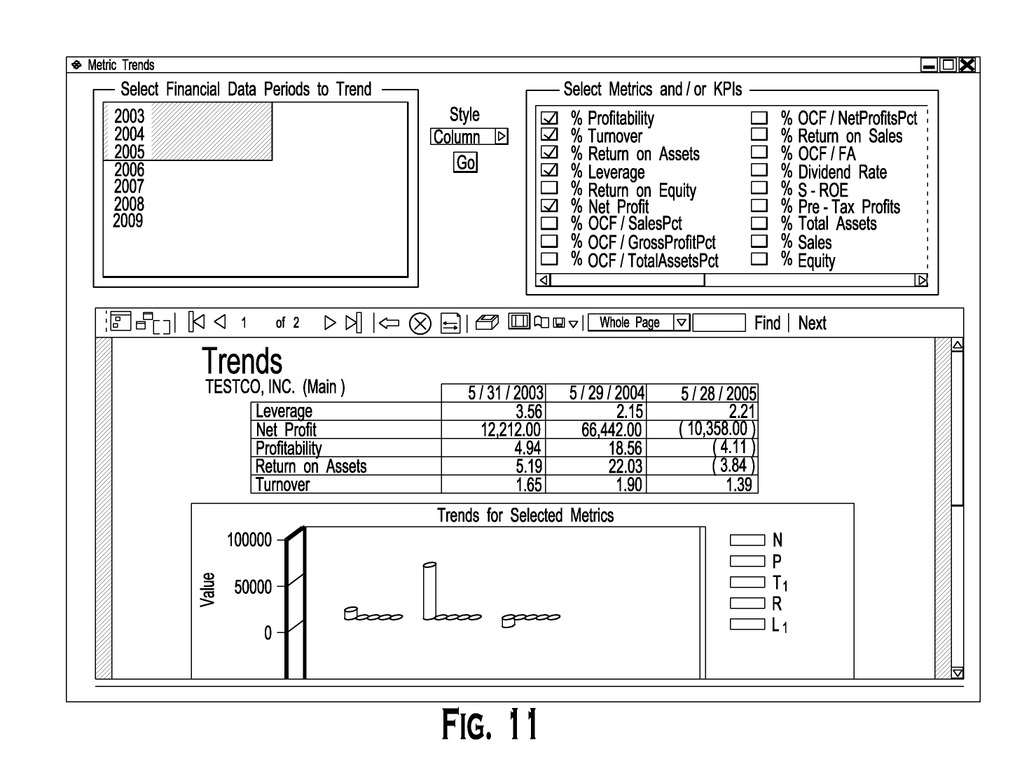

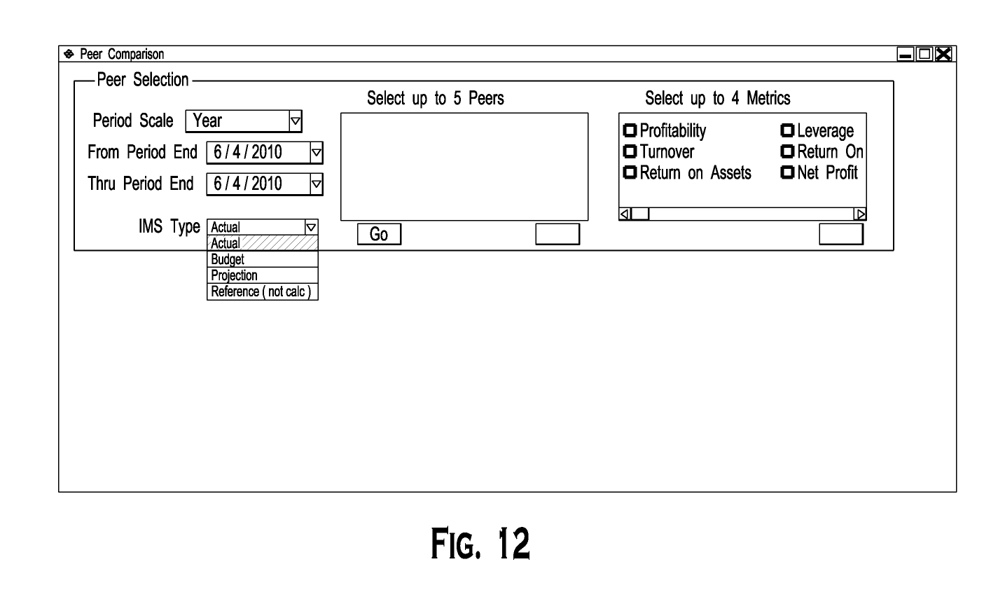

The metric trends component 247 and peer/reference comparison component 248 generate a reports through the analysis module 60. The user selects from various time periods and selected metrics, including financial and non-financial metrics, such as the selected entities key performance indicators (KPIs). The metric trends component 247 generates a graphical representation of selected metrics over selected time periods (see FIG. 11), while the peer/reference comparison component 248 generates a reports casting select entity calculated metrics against peers and or benchmark standards (see FIG. 12). As a result, the user can use these reports to analyze business performance from a number of perspectives of entity infrastructure.

The data linkage manager component 260, shown in FIG. 5, is another component in the assessment, financial work up, and action plan component 200 of the performance management system 1, and is positioned sequentially after the financial data analyzer component 240. The data linkage manager component 260 allows the user to align a selected metric from the assessment builder component 220 with metric drivers. In the embodiment shown, the data linkage manager component 260 includes a number of drop down menus and buttons that link to various functional components, which offer the user with a variety of option to custom business performance action plans.

Generally, an action plan provides a user with a unique opportunity to link financial information to strategic information and/or operational action items. Additionally, these action plans allow the user to compare information to a peer group having similar information, which allows the user to determine a selected entities variance at each metric driver. Furthermore, it allows the user to select which metrics need further performance and map these metrics to action items that may enhance performance.

The user can select an existing action plan, through the drop down menu, or prepare a new action plan, using the create a new plan from baseline component 262. The user can also review or edit a selected action plan through a view/edit component 264.

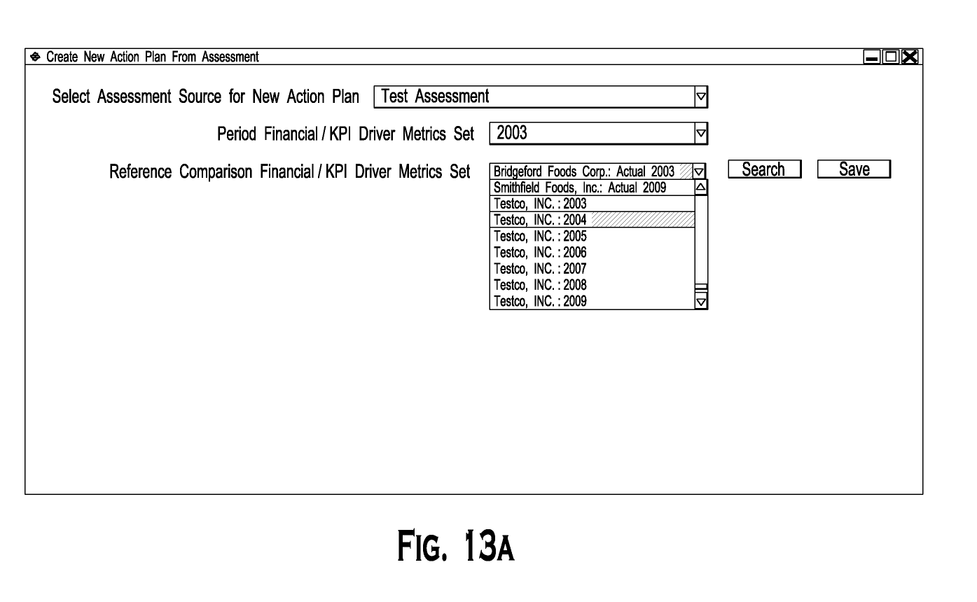

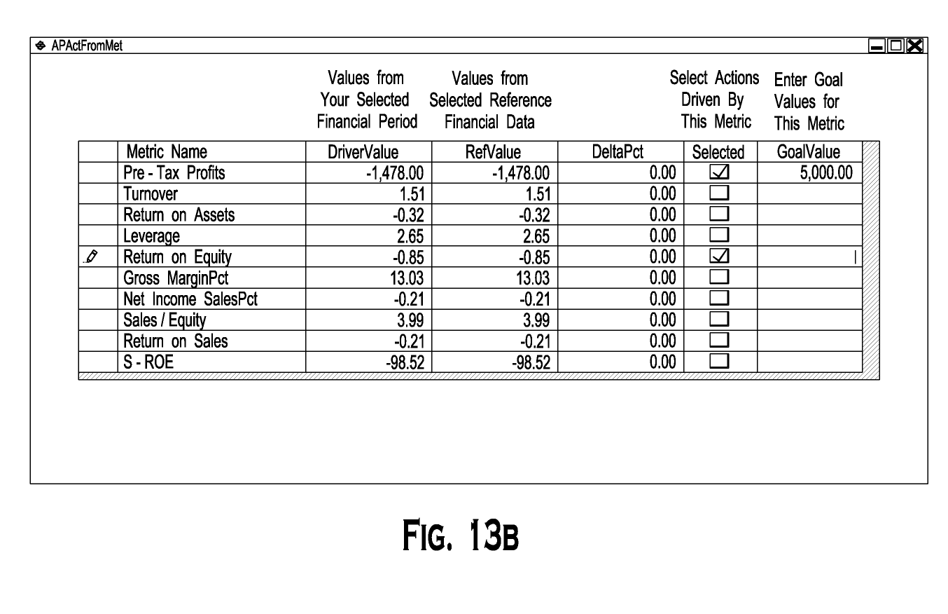

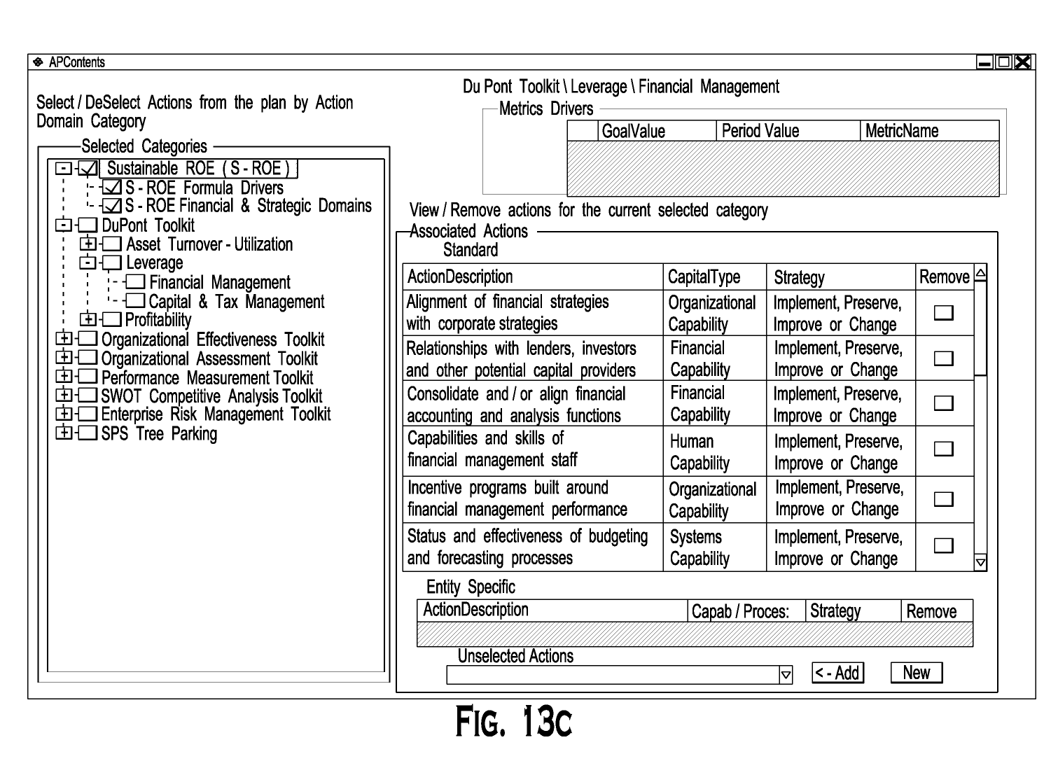

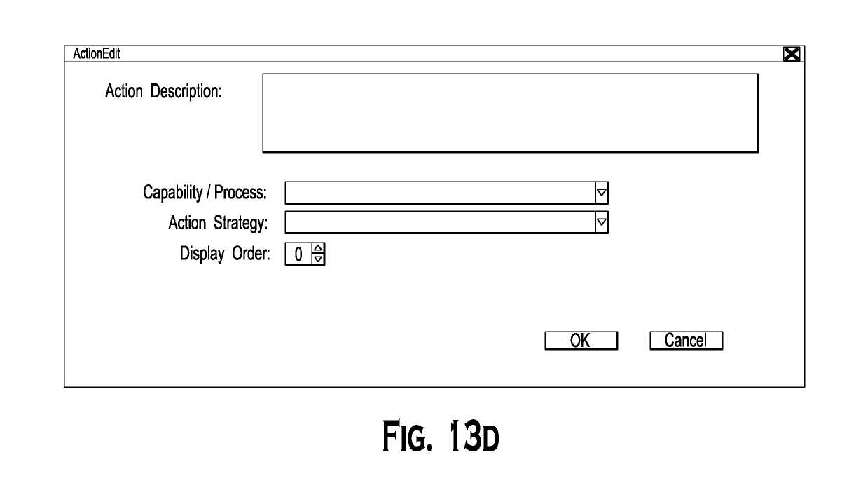

An exemplary user interface screen for the create a new plan from baseline component 262 is shown in FIG. 13a, where the user can create an action plan. The user selects an assessment created in the assessment builder component 220 for a selected entity, and then selects the period financials and key performance indicators (KPIs) metrics sets that have been prepared and generated in the financial data analyzer component 240. In addition, the action plan will include the reference comparison financial/KPI driver metric set, which was also prepared and generated in the financial data analyzer component 240.

A select actions from metric drivers and enter metric goals 266 is provided as separate functional component to the data linkage manager component 260. By selecting the button (select actions from metric drivers and enter metric goals 266), the applications module 20 brings up a separate window, which displays metrics and corresponding values from the data sets selected in the financial data analyzer component 240, as shown in FIG. 13b. Financial and non-financial metrics are listed. In another listing, reference data (i.e. metric values of peers or benchmark data) is listed to assist the user in focusing in on particular actions driven by the valued metric. A Delta Pct column, in shown embodiments, shows a variance between the driver value and reference value. The user can select the metrics that the user would like to focus on by click on the box in the selected column. The Goal Value, in the embodiment shown, is an area provided for you to enter what you wish to use as your measurable target to obtain during this process. The user can enter these goals for a particular metric, such as an achieved value for the financial or non-financial metric, key performance indicator (KPIs). As a result, the action plan is focused for a selected entity. If the user wants to further refine the action plan, in accordance with certain action items, the user can utilize an edit action plan contents component 268.

The edit action plan contents component 268 is another component of the data linkage manager 26, and allows the user to review selected action items from the action library module 15. A window, shown in FIG. 13c, is brought up when the edit action plan contents component 268 is user selected. Since each toolkit contains a list of action items, which are shown in another window pane, the edit action plan contents component 268 permits the user to further focus and tailor action items based on review and analysis performed through the financial data analyzer component 240 or baseline responses added through the assessment builder component 220. Each action item is again identified by action description, capability, and strategy. Under the action library module 15, action items are listed and correspond to a certain toolkit sub-category, as discussed above. However, the user can now remove an action item from the selected action plan if the user determines to focus on other action items. At this point, the user can also add action items that were yet selected, as shown in FIG. 13d. As a result, the edit action plan contents component 268 allows the user to define a specific action plan according to areas that the user believes requires better performance. Selected categories and standard action items associated with the selected metrics will serve as core strategy items in developed action plan.

The maintain and monitor action plan component 280, shown in FIG. 5, is another sequential component in the assessment, financial work up, and action plan component 200 of the performance management system 1. The maintain and monitor action plan component 280 provides the user various options to report on the selected action plan, and is driven by the monitoring and reporting modules 80, 100 of the performance management system 1.

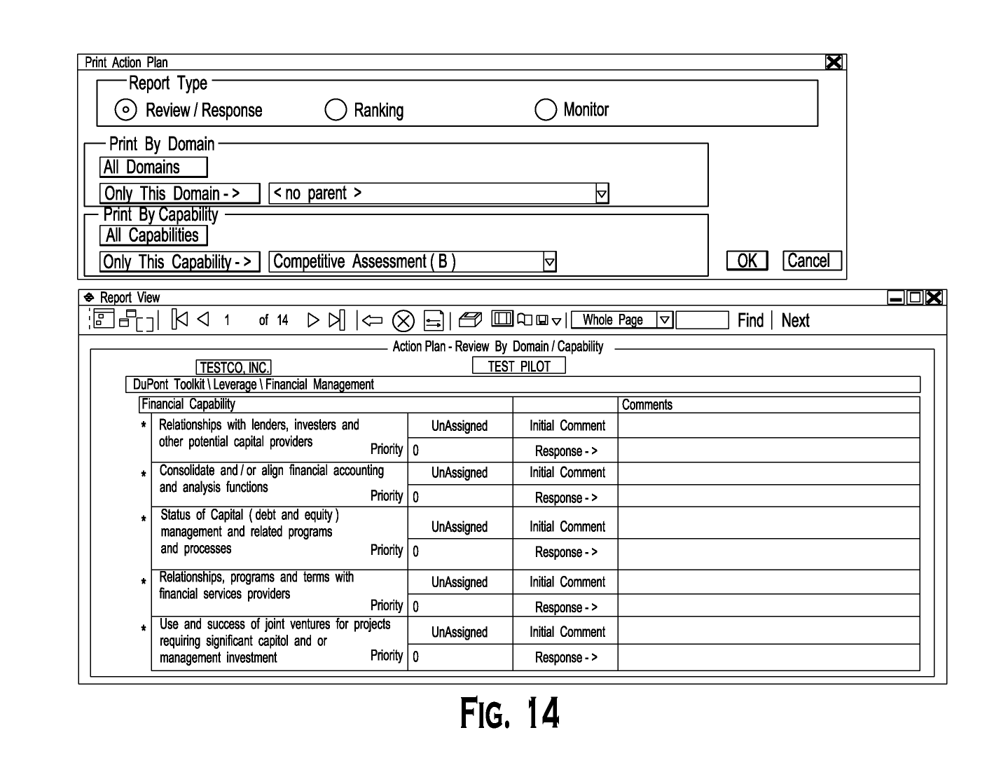

In the embodiment shown in FIG. 5, the maintain and monitor action plan component 280 has a drop down menu to select from action plans for a select entity prepared through the other sequential functional components on the assessment, financial work up, and action plan component 200. A view/print action plan working documents 282 provides the user options for reporting the selected action plan, as shown in FIG. 14. First, the user selects the type of report to be prepared. In the embodiment shown, the user selects from a review/response, ranking, or monitor report. Additionally, an exemplary review/response report is shown in FIG. 14, and includes a listing of selected action items with fields for comments and assignments. The user can utilize this type of report at meetings in order to discuss the action items of the action plans with regard to performance and how to best respond. The ranking report provides the user an ability to assessment rank and prioritize action items from the selected action plan. The monitor report provides the user an ability to track and monitor action items based on metric values and goals associated with the action items. Additionally, the user has the ability to prepare a report by toolkit domain/sub-domain from the action library module 15 or by capability, which provides action items associated with the selected capability.

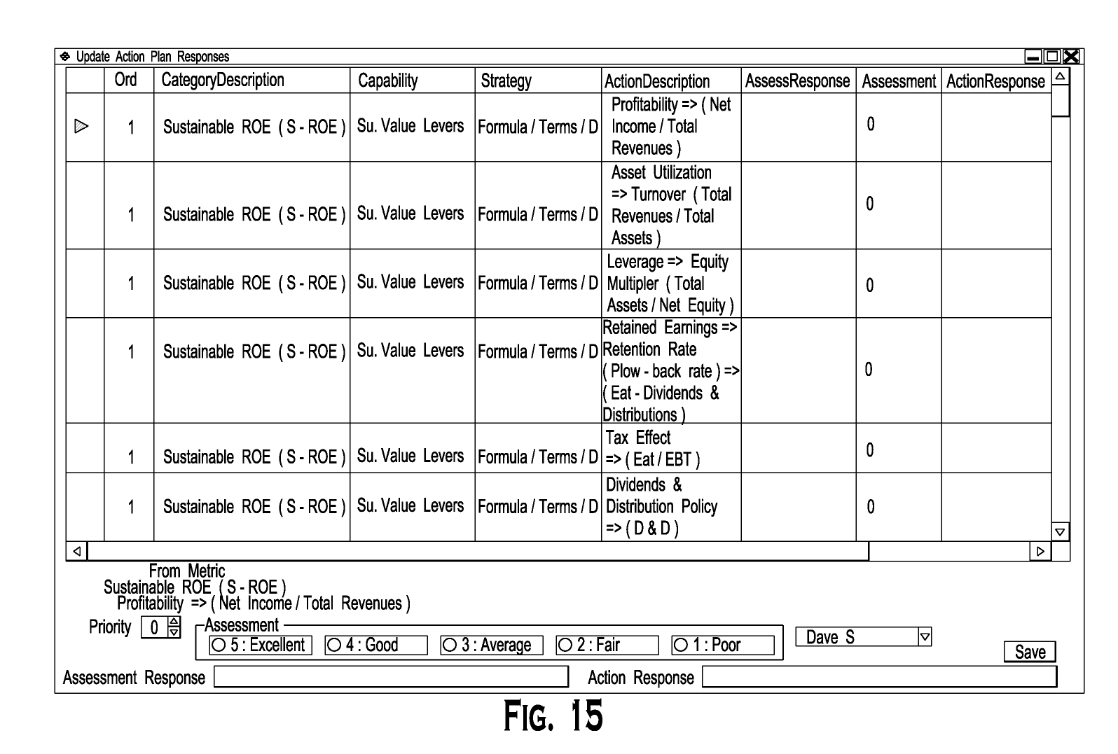

The maintain and monitor action plan component 280 includes an update action plan responses component 284, as well, as shown in FIG. 15. When selected, the update action plan responses component 284 allows user to update action item responses from the baseline responses prepared through the assessment builder 210 of the selected action plan. In the embodiment shown, the action items are listed with columns for baseline responses and values next to action plan responses and value. The user can assign each action item a priority, person responsible and some additional notes about the action item. In addition, the user can also assess the state of the action item in case the user desires to see how this may be improving as you work on the items. A response field is also provided to allow for input in relation to the assessment.

This completes the sequential steps and functions provided through the assess component 20a. As discussed above, the link/plan component 20b is similar to the assess component 20a, having the same functional components. However, the link/plan component 20b allows the user to return the last analysis settings and functions prepared by the user for a selected entity.

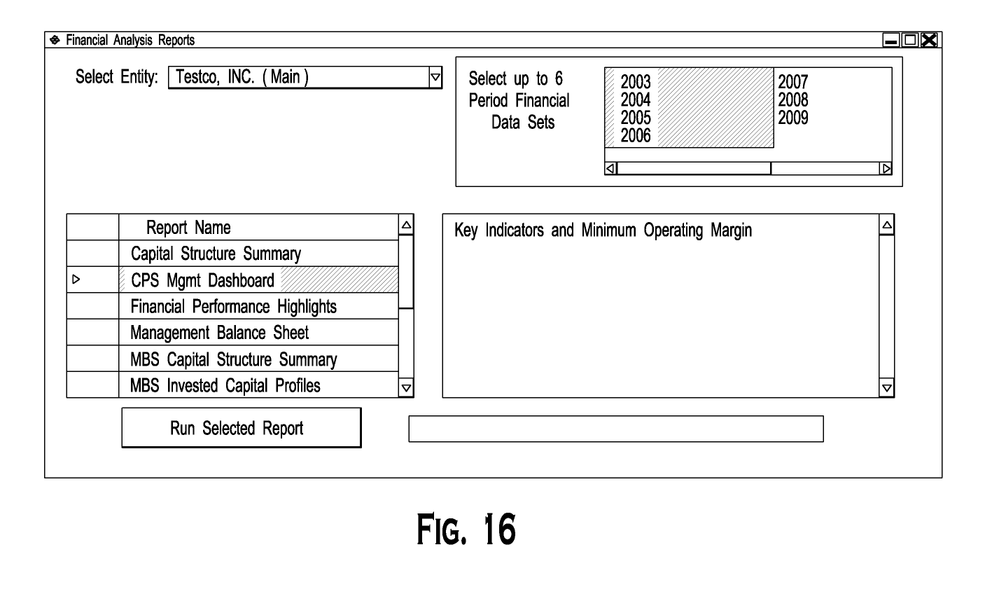

The analyze component 20c provides the use of the performance management system 1 the ability to generate various reports based on assessments, financial data, and action plans generated for a selected entity from a single window. In the embodiment shown in FIG. 16, the user can select from any existing entity having data inputted and stored through the assess component 20a. Financial data sets that have been stored for the selected entity will appear, and be listed by time period. The user has the ability to select several data sets in order to generate the report. The selected data will be analyzed and a selected report will be generated. In the embodiment shown, the performance management system 1 can generate a capital structure summary, a management dashboard, a financial performance highlight report, a management balance sheet, a MBS capital structure summary, a MBS invested capital profiles report, a MBS working capital summary, a mulit-preiod balance sheet, a multi-period cash flow report, a multi-period income statement, and/or a value drivers reporting implementing the Shattuck-Hammond minimum operating margin (SHMOM). One of more of these reports can be combined into a larger report, and is driven by the assessment, analysis, and reporting modules 40, 60, 80.

The capital structure summary provides a report detailing the way the selected finances its assets through some combination of equity, debt, or hybrid securities. The capital structure summary provides information on net assets, financing, and capital costs, including illustrated capital trends and capital employed trends.

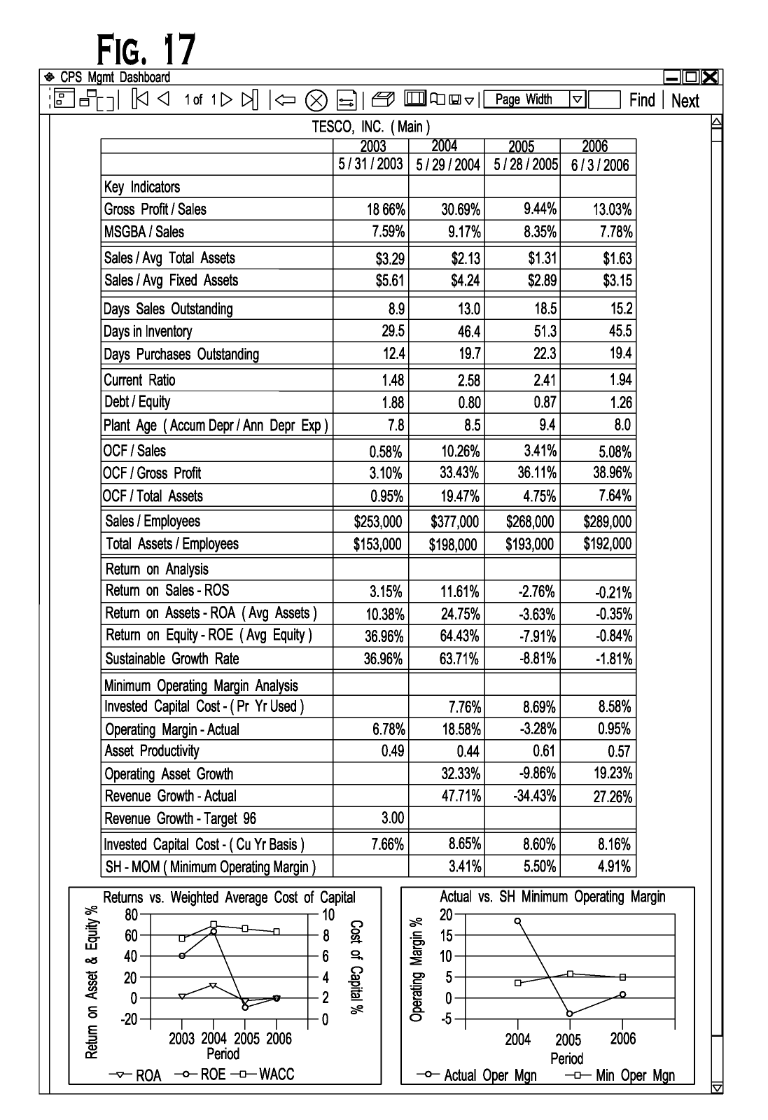

The management dashboard report, partially shown in FIG. 17, includes an analysis of key performance indicators and a calculated a minimum operating margin (MOM), developed by Shattuck-Hammond based on a revenue growth target inputted by the user.

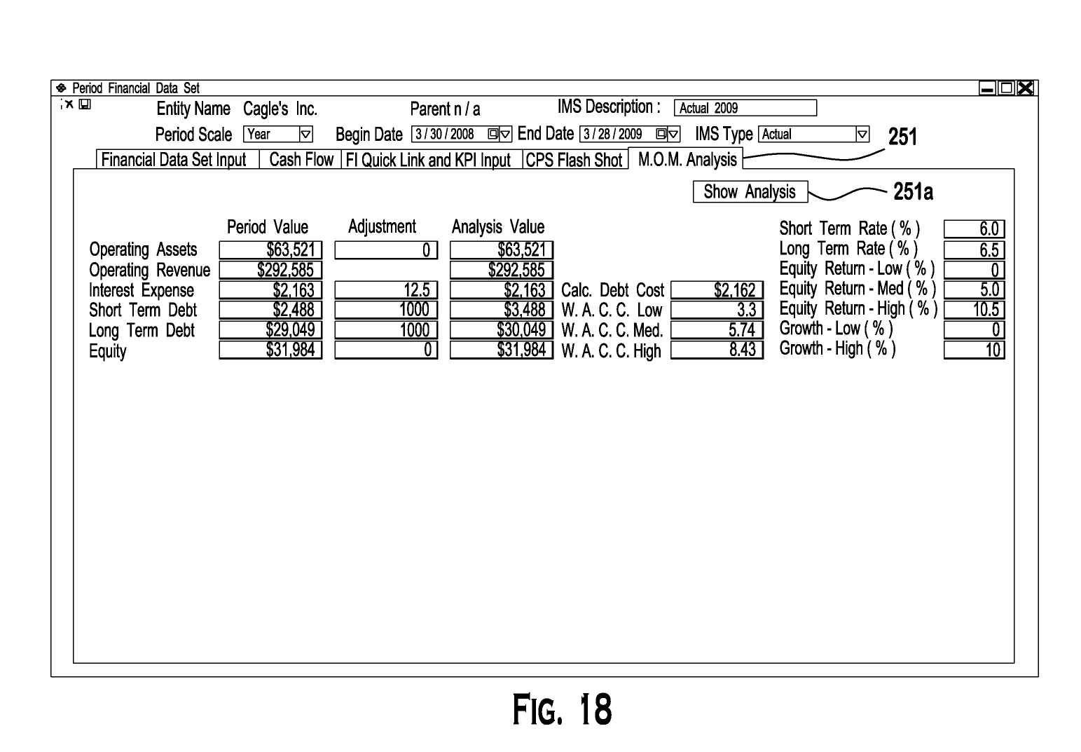

In another embodiment, a Shattuck-Hammond Minimum Operating Margin (SHMOM) calculation as automated within the performance management system 1. As shown in FIG. 18, a minimum operating margin component 251 is included in the period financial data set component 250, and is an additional data set. The minimum operating margin component 251 draws information calculated and stored as part of the period data set for a specific year. This is displayed in a first column minimum operating margin component 251, as shown.

The performance management system 1 allows “what if” scenarios, by allowing a user to adjust the data for new loans, assets, and revenue. Data can be entered in a second column minimum operating margin component 251.

A third column of the minimum operating margin component 251 contains adjusted analysis values for interest that is calculated to cross check with actual interest—and the average weighted cost of capital (WACC) under a low, medium, high capital cost scenarios, which is calculated into a column four as well as the data values input in column five. These values relate to cost and growth assumptions.

A show analysis component 251 a generates a graphical report, where three scenarios, in the embodiment shown, illustrate the required minimum operating margin, also referred to as the minimum operating margin (MOM). This depicts what is required to cover the cost of a capital under various growth assumptions. This analysis allows a particular year of financials to be modified and capital performance to be linked to target minimum operating margins under various growth assumptions—therefore, allowing the historical financial perspective to be used to develop scenarios with target the minimum operating margin (MOM) to cover the required cost of capital (e.g.—the capital profile (balance sheet) is effectively linked to the operating performance (income statement) for forward looking measurements). This provides a user the ability for computing and storage multiple scenarios based on the same period values. This allows for dynamic scenarios to be compared in an automated process.

All reports within the performance management system 1 can be printed or exported from the software as a .xml, .csv, .pdf, .mhtml, .xls, .tiff, or word file. It is also possible that the system utilizes frames through a single user interface widow, where the functional components, such as the assess component 20a, the link/plan component 20b, the analyze component 20c, the action library component 20d, the lookup maintenance component 20e and the security component 20f, are provided in a single window frame that changes based on function selected. Therefore, the user needs only work in one window to perform operations with the performance management system 1.

The foregoing illustrates some of the possibilities for practicing the invention. Many other embodiments are possible within the scope and spirit of the invention. The reports shown in the specification are merely exemplary embodiments and the spirit of the invention incorporates a custom report having the details listed above. It is, therefore, intended that the foregoing description be regarded as illustrative rather than limiting, and that the scope of the invention is given by the appended claims together with their full range of equivalents.

What is claimed is:

1. A performance management system, comprising:
hardware; and
software tracking performance of entity's goals and objectives, assessing the entity's financial metrics, non-financial metrics, strengths and weaknesses relative to industry standards, and setting and monitoring custom action plans through a single general user interface (GUI).

2. A performance management system comprising:
a database module collecting and storing data;
an action library module maintaining performance analysis toolkit domains and sub-domains having action items stored in the database module;
an application module allowing a user to perform multiple related specific tasks through a single general user interface (GUI);
an assessment module providing a customized assessment of business performance through a selected domain action item;
an analysis module providing analytics of an action plan customized from the selected domain action item linked to a metric of the action plan; and
a reporting module communicating a simple integrated financial snapshot of business performance over a period of time.

3. The performance management system according to claim 2, wherein the database module provides inbound and outbound data transfer.

4. The performance management system according to claim 2, wherein the action library module assigns domain action items to the metric of the action plan.

5. The performance management system according to claim 4, wherein the metric is selected from one of a financial metric or a non-financial metric.

6. The performance management system according to claim 6, wherein the non-financial metric is a key performance indicator (KPI).

7. The performance management system according to claim 2, wherein the domain action items are used to assess and track performance outcomes with objectives.

8. The performance management system according to claim 2, wherein the application module comprises code controlling the general user interface and has a set of command buttons to activate code function and links.

9. The performance management system according to claim 2, further comprising a monitoring module providing user ability to monitor the action plan customized from the selected domain action item linked to a metric of the action plan.

10. The performance management system according to claim 2, wherein the analysis module performs trend, peer and industry benchmarking analysis.

11. A performance management system, comprising:
an assess component selecting an action plan for a selected entity, the action plan linking a baseline assessment and financial data;
an analyze component running a financial analysis of the selected entity based on input from the asses component; and
an action library component storing and maintaining at least one business analysis or toolkit having at least one action item.

12. The performance management system according to claim 11, further comprising a lookup maintenance component defining master files for available unique/customizable configurations.

13. The performance management system according to claim 12, wherein the lookup maintenance component performs master table maintenance for a database.

14. The performance management system according to claim 11, wherein the baseline assessment includes a selected action item from the action library component.

15. The performance management system according to claim 14, wherein the selected action item is linked to a selected action metric.

16. The performance management system according to claim 15, wherein the action is selected from one of a financial metric or a non-financial metric.

17. The performance management system according to claim 16, wherein the non-financial metric is a key performance indicator (KPI).

18. A performance management system, comprising:
an entity selection component for selecting an entity to analyze;
an assessment builder component for analyzing and assessing business performance of the entity through a select action item associated with a business analysis or toolkit;
a financial data analyzer component for entering financial data associated with the entity;
a data linkage manager component for generating a custom action plan; and
a maintain and monitor action plan component for reviewing and monitoring the custom action plan.

19. The performance management system according to claim 18, wherein the assessment builder component configures the selected entity with associated assessment criteria.

20. The performance management system according to claim 19, wherein the assessment criteria is a selected action item and a linked metric.

21. The performance management system according to claim 20, wherein the linked metric is from one of a financial metric or a non-financial metric.

22. The performance management system according to claim 18, wherein the financial data analyzer component links actual or projected financial data and non-financial metric values to the select action.

23. The performance management system according to claim 18, wherein the financial data analyzer performs analysis metric trends, and reviews peer/benchmark comparisons.

24. The performance management system according to claim 23, wherein the financial data analyzer generates a report listing and illustrating a summary of financial balances.

25. The performance management system according to claim 23, wherein the financial data analyzer generates a report listing and illustrating a graphical representation of selected metrics over selected time periods or a reports comparing select entity calculated metrics against peers and or benchmark standards.

26. The performance management system according to claim 18, wherein the custom action plan provides a link between financial information and strategic information and operational action items.

27. The performance management system according to claim 26, wherein the custom action plan is selected from an assessment created in the assessment builder component and selected time periods of financial data and a metric generated in the financial data analyzer component.

28. The performance management system according to claim 27, wherein the custom action plan includes metric goals.

29. The performance management system according to claim 27, wherein the data linkage manager component includes an edit action plan contents component to review the select action item and select another action item.

30. The performance management system according to claim 18, wherein the maintain and monitor action plan component generates a report on the action plan.

31. The performance management system according to claim 30, wherein the report is a review/response, ranking, or monitoring report.

32. The performance management system according to claim 31, wherein the review/response report includes a listing of selected action items with fields for comments and assignments.

33. The performance management system according to claim 31, wherein the ranking report includes an assessment, rank, and prioritize action items component for the action plan.

34. The performance management system according to claim 31, wherein the monitoring report is a report listing action items based on metrics values and goals associated with the action items.

35. The performance management system according to claim 18, wherein the maintain and monitor action plan component includes an update action plan responses component to update action item responses from a baseline response prepared through the assessment builder component.
